(19) United States
(12) Patent Application Publication
(10) Pub. No.: US 2016/0161940 A1
(43) Pub. Date: Jun. 9, 2016

(54) INTELLIGENT WATER EMERGENCY SYSTEM

(71) Applicant: Yaakov S. MAX, Brooklyn, NY (US)

(72) Inventor: Yaakov S. MAX, Brooklyn, NY (US)

(21) Appl. No.: 14/560,544

(22) Filed: Dec. 4, 2014

(51) Int. Cl. G05B 19/416; G05D 7/06

(52) U.S. Cl. CPC G05B 19/4166; G05D 7/0635; G05B 2219/37371

(57) ABSTRACT

An intelligent water flow control system is coupled with a main water flow source and controls the water flow by controlling an electrical valve in line with the water source and making a determination by receiving information from one or more water flow detectors. The system controller executes that software which issues information from the one or more flow detectors and output signals for controlling the open or closed state of the various valves. The software makes determinations on whether a leakage condition is present and issues the valve control signals to shut off the necessary valves and to report to a user, the occurrence of a leakage condition.

### BACKGROUND OF THE INVENTION

The present invention is generally directed to water supply control systems and, more particularly, to an intelligent water control system for shutting off the water main, and optionally, subsidiary branches of the water plumbing at a home or a business automatically and optionally in direct response to wireless remote instructions from a user.

As is well known, frozen pipes that thaw oftentimes flood homes or business establishments. Automatic water feeders that go bad do not stop running. Similarly, a broken hot water heater will continue spewing water flooding one's basement floor. Broken washer hoses and fridge lines do not stop running until found, and turned off. When people are not at home, or just not aware of a broken pipe, the property losses can be huge. It is a common occurrence that causes millions of dollars in yearly losses to homeowners, business entities and insurance carriers. There is a need for effective damage control to mitigate such losses. Controlling this problem can also result in savings realized on water conservation.

Before the advent of electrical and/or electronically controlled water valves, home and business owners' only option in an emergency flood, or normal plumbing repair situation, was to manually shut off the water main master valve, upstream of the leak or plumbing repair site. More recently, the prior art has developed electrically operable and electronically controlled water valves that afford the option of controlling water supply lines electronically, including via remote electrical switches and wireless controllers.

U.S. patent publication 2011/0248199 describes an electrical valves that is electronically controlled to shut off water valves, including via a wireless remote control mechanism using controls known in the art, such as those sold by X10, for example. It mentions controlling water valves via an Internet connection. Other prior art patents discuss electronic controls for water valves including U.S. Pat. Nos. 6,237,618; 6,532,297 and 6,929,240. The entire contents of the aforementioned United States published patent application and issued patents is incorporated by reference herein. Other prior art which deals with electronically controlled valves includes U.S. Pat. No. 6,730,554 and U.S. published patent applications 2008/0048143; 2004/0194208; and 2005/0082502. The entire contents of the aforementioned U.S. patent and published patent applications are similarly fully incorporated herein by reference.

Still, there are drawbacks to the known water controlling systems of the prior art. For example, to the present knowledge of the instant inventor, prior systems, even when remotely operable, require human intervention to activate the water shutting function. One prior art system uses an auto shutoff that only works if water hits the sensor. They are not imbued with the knowledge and intelligence about the history of water usage at each particular location, to be able to distinguish between a true emergency involving a major breech of the water supply system, as compared to a situation where lots of water is being used when, for example, all the members of the family are simultaneously using all of the available water sources in the particular location. The prior art also does not take into account the likelihood that a water supply leak may happen as a result of a prolonged disruption of the electrical system which shuts down a building's heating plant during a cold winter, thereby causing freezing and plumbing damage. During power outages, there is no way to communicate electronically and to provide electrical alerts to an owner of a home or a business, nor to actually control electronically the various water supply valves to effect shutting off of the water supply.

Another drawback of the prior art is that even where water sumps are provided to drain away water in a basement and the like, these water sumps are not electrically integrated with systems that control the water supply to the building.

### SUMMARY OF THE INVENTION

Accordingly the overall object of the present invention is to overcome the aforementioned and other drawbacks of the prior art.

Another object of the present invention to provide an intelligent water emergency handling system which features a system that learns the water consumption habits within a controlled area during different times and stores information thereabout.

It is another object of the invention to provide a system that electronically controls the main water valve, as well as secondary valves that are strategically placed at a controlled building location.

It is yet a further object of the invention to provide an Internet-enabled monitoring system for a water supply system that is remotely controllable.

It is still a further object of the invention to provide a water emergency system that is provided with battery backup power, so that it can operate even when electrical power to a given location has been disrupted.

The foregoing and many other objects of the invention are realized in the form of the disclosed intelligent water emergency system which comprises: a main water flow source conduit for supplying water to a location having at least one water branch in liquid communication with the water source conduit; at least one electrical valve located in line with the source conduit; at least one water flow detector coupled to said at least one water branch; a controller with internally stored software, said controller being electrically coupled to receive information from the at least one flow detector and coupled to output signals for controlling the at least one valve; and wherein said controller is configured to executed software that is effective to gather information about water usage from information derived from said at least one flow detector and to develop information indicative of normal water usage at the location, and to make leakage determinations indicative of out of normal water usage at the location and to interact with said at least one valve to shut off water passage through said valve.

The flow detector may be a water flow meter or a sound detector for detecting the sound of flowing water. The water valves and detectors can be installed at the location at many branches of the water system. The controller may be in hardwire or in wireless communication with the water valves and the flow detectors.

The system software develops a water usage profile that gathers information and develops the profile by storing information about the times of day when the water usage typically occurs, water usage durations, operator entered parameters, such as whether the location is in a vacation mode or the number of people that reside at the location and the like. The water usage profile may take into account many other factors, including instantaneous water quantities flowing from the water source and water usage quantities flowing over selected time periods, or an outside temperature sensor, calendar or third party inputs.

Other features and advantages of the present invention will become apparent from the following description of the invention which refers to the accompanying drawings.

### BRIEF DESCRIPTION OF THE DRAWINGS

FIG. 1 diagrammatically illustrates main aspects and elements of the intelligent water supply control system according to the invention.

FIG. 2 is a block diagram of major components of the controller of the intelligent water supply control system of the present invention.

FIGS. 3a and 3b illustrate water flow meter aspects of the present invention.

FIG. 4 illustrates a manual bypass for an electrical water valve.

FIG. 5 is a flowchart of certain algorithms utilized in the computer controller of the invention.

### DETAILED DESCRIPTION OF EMBODIMENTS OF THE INVENTION

The concepts and instrumentalities that help mitigate the various drawbacks mentioned above can be appreciated from the instant drawings and the following descriptions, which refer to the drawings.

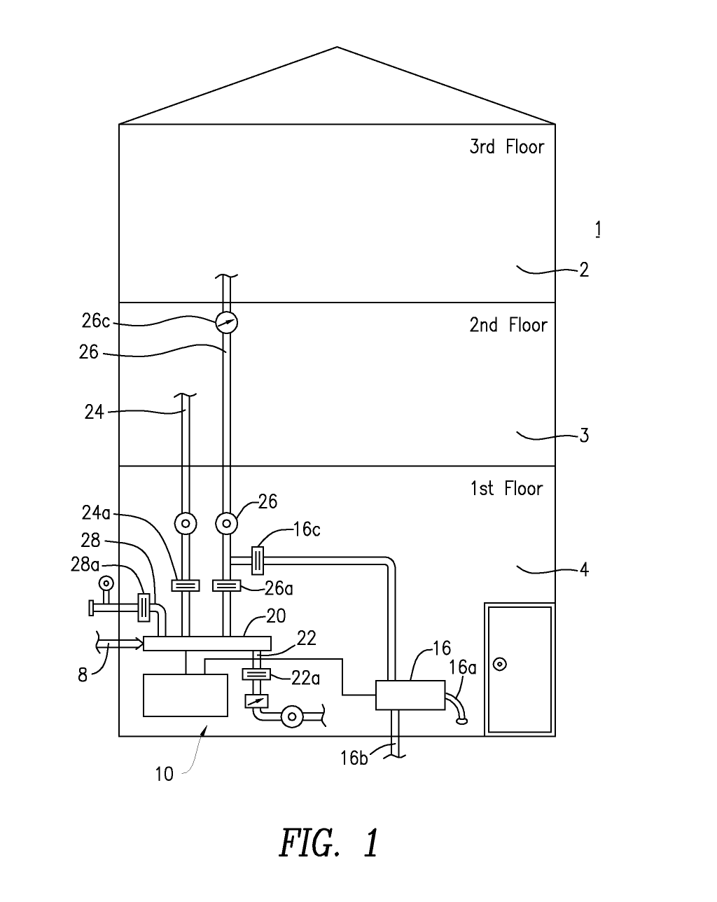

In FIG. 1, the home 1, which includes a third floor 2, a second floor 3 an a first floor 4, is outfitted with an electrical water control system 10, which is preferably located on the lowest floor, for example, the first floor 4. In accordance with the invention, the water utility provides the main water source through the main water pipe 8 which feeds the water manifold 20 which is controlled by the controller 10, in order to regulate the supplying of water to the various floors, as well as to the perimeter outside the home 1. To this end, the manifold 20 delivers water via a first water conduit 22 to the first floor, a second water conduit 24, a third water conduit 26 and a fourth water conduit 28. The water manifold 20 may contain a master electrical valve as described further on. In addition, water flow sensors/meters sense the waterflow and the controller learns the waterflow patterns and habits within the home 1 over various time periods, developing a histogram of water usage to enable it to determine anomalies, which are indicative of breach of the water supply system in the form of a leak, a major pipe burst, or the like.

For example, each water branch 22, 24, 26, 28 preferably has an electrical water valve, respectively identified as water valve 22a, 24a, 26a, 28a which can be individually controlled by the system controller 10 to be shut off or turned on as needed. Each of the water branches may also include its own water flow meter. For example, the water flow meter 26b is configured to report to the controller 10, either by being directly hardwired to it or via known wireless communication means, the flow rate in the particular branch to enable developing the necessary history and base line for obtaining the overall control provided by the present invention, as described in greater detail further on. Although the electrical water valves are shown located in proximity to the controller 10, it should be appreciated that these valves can be located remotely, for example, on a different floor or at a remote sub-branch, so that the water flow to the sub-branch can be shut off independently of the water flowing in the branch itself.

An optional feature may include a temperature sensor, for example, temperature sensor 26c in the branch 26, which detects and reports the pipe temperature outside within the particular branch to enable determining whether to shut off the particular branch if, for example, the temperature reported is below 40° F., which is indicative of a home or a location moving toward experiencing frozen water pipes. Alternatively, the system can call and get the weather data from a central station or weather bureau.

The overall system of the invention can also provide the option of interfacing itself to a sump pump 16 with a sucking pipe 16a which collects water off the floor of the home and delivers it to a sewer line via an output 16b. In this connection, it is also within the realm of the invention to provide a direct connection between the sump motor 16 and the individual water branches, for example, the branch 26 at the location directly beyond the electrical water valve 26a, via an installed electrical valve 16c. This facility provides the option that if it is detected that there has been a leak in the water branch 26, the controller 10 controls the electrical switch 16c to open and so allow the standing water in the water branch 26 (after the valve 26a has been closed) to flow to the sump to localize the damage and prevent further damage to the water branch 26.

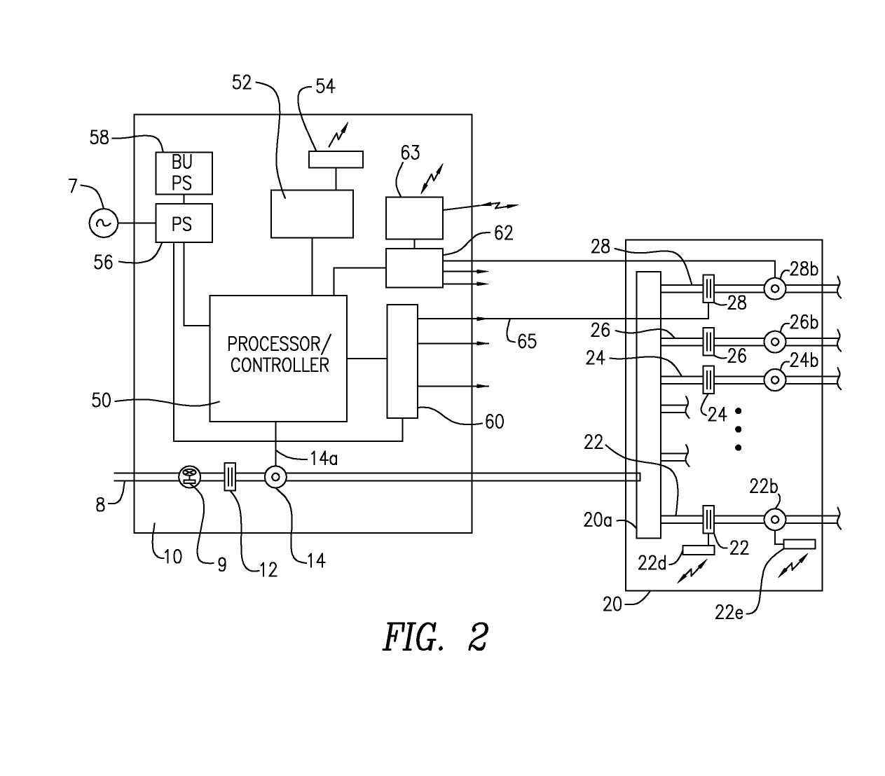

The foregoing and additional details of the system controller 10 are further described by reference to FIG. 2. Thus, the electronic water control system 10 includes a CPU or central processor or controller 50 which, in conventional manner, contains internal memory and stored software to execute various algorithms to collect information and to store same in a memory to thereby provide control signals to the water valve driver 60 that provides individual controls to the water valves, such as to the main electrical water valve 12, and to the subsidiary water valves (FIG. 1), such as the water valves 22a, 24a, 26a, and 28a.

Typically, the processor would run on a low voltage of 5 volts DC, supplied by the power supply 56 which converts the A/C provided by the local utility. The power supply also develops a 24 volts A/C power which is supplied to the valve driver 60 to operate the valves. Also depicted is a backup power supply 58 which comprises various batteries that remain charged with enough battery power to run the overall electrical system 10, say for a period of one week, assuring continuous operation even during extended electrical power disruptions. A turbine generator may be used to activate itself and generate the needed power when the utility power has been disrupted for more than a short time.

The processor 50 is also interfaced with the water flow meter/sensor 14 via a line 14a, which supplies it information about the aggregate water consumption in the home, via the main water line 8, which is also gated by the conventional, manual water valve 9, as shown.

The processor 50 also interfaces with the various water flow meters in the system via an interface 62 which can provide a direct hardwired connections to these water flow meters 22b, 24b, 26b, 28b or, this is provided wirelessly through, for example, a wireless Bluetooth® or local network, or the Internet, or the like, which is implemented in conventional ways via the wireless communication block 63. Thus, water usage readings provided by the flow meters 22b, 24b, 26b, and 28b can be supplied to the processor 50 via hardwire, as indicated by the hardwire line 65 or wirelessly through the wireless facility 63, as explained. Naturally, for wireless communication, it is also necessary to provide a local facility at each electrical valve or meter, such as indicated by the wireless facility 22d for water valve 22 and a wireless facility 22e for the flow meter 22b (FIG. 2).

As will be explicated later on, the processor 50 is also in communication with the user interface 52, through which the user/operator can input various control modes and optional settings. The external wireless facility 54 is in communication with the processor 50 and includes therein the modem necessary for wireless communication over conventional telephone cellular networks, whereby the processor can send and receive various messages or email communications to an operator who may be located remotely, e.g., in another country, and receive return information as to how to control the overall system. As another expedient, users may entrust the overall control to a central station manned by professionals who monitor for people their home for burglaries and the like.

For water flow measurements, reference is made to the widely developed and known facilities for measuring liquid flow in a pipe. Accordingly, the present invention can use any or a variety of the following types of liquid flow meters known in the art, including mechanical flow meters, pressure-based meters, optical flow meters, open-channel flow measurements, current and mass flow meters, vortex flow meters, electromagnetic, ultrasonic and coriolis flow meters, and Doppler flow meters. The mechanical flow meters may utilize a piston meter/rotary piston arrangement, gear meters utilizing either oval gear meters or helical gear or nutating disc meters. Other meters in this category include variable area, turbine flow, Woltmann®, single jet, paddle wheel, multiple jet, Pelton® and/or current meters. The pressure-based meters include the venturi meter, the orifice plate, the Dall 2, the Pitot tube, the multi-pressure probe and the cone meter. The thermal mass flow meters include the MAF sensor. Electromagnetic/ultrasonic/coriolis flow meters can use magnetic flow meters, non-contact electromagnetic flow meters, ultrasonic flow meters (Dopplers, Transit Time) and coriolis flow meters.

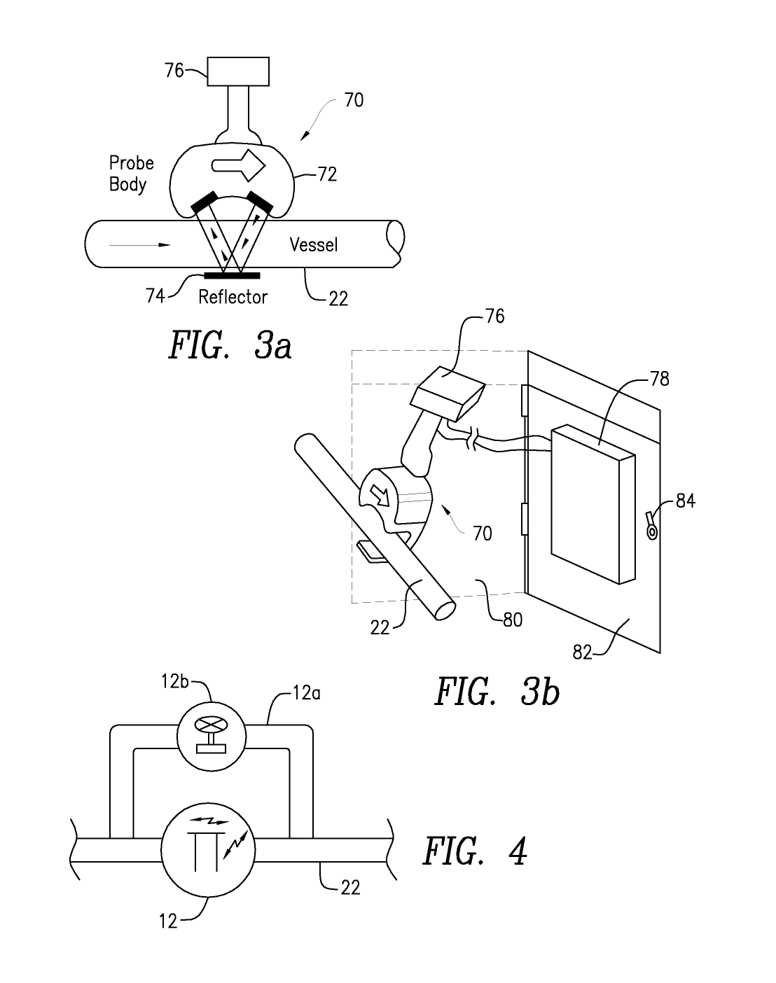

An example of an ultrasonic flow meter is illustrated in FIG. 3a showing the pipe 22 to which it is coupled, non-invasively. The flow meter 70 which has a probe body 72 with a pair of emitters angled relative to each other to pass ultrasonic waves through the pipe 22, striking reflector 74 and returning to the probe. By transmitting from one emitter to the other receiver (acting as a receiver) in one direction and then reversing in the other direction, the flow speed, and therefore flow rate can be determined. The probe electronics 76 can be used to communicate the sensed data either wirelessly, or by hardwire, as previously described.

The same ultrasonic flow meter 70 is shown in FIG. 3b, coupled to the pipe 22 and exposed through an opening 80 in a wall with the flow meter 70 attached thereto. The opening 80 is normally covered by a hinged door 82 having a lock 84 and an electronic panel 78 which is connected by cable to the probe electronic 76 to provide electrical power via stored batteries or through A/C power, to so power the probe electronics to handle the necessary flow measurements and to report results to the central processor 50. It is noted in passing that instead of a flow meter, the invention can deploy a sound detector that senses the flow of water in a pipe by listening to the sound being generated in providing a yes/no response, e.g., one or zero signal to the computer to alert the computer is water is flowing in the branch or not flowing and the computer merely integrates the time that water is flowing to develop a develop a particular type of water usage histogram.

Inasmuch as the present disclosure uses many electrical valves, such as the valve 12 located in the pipe branch 22, the inventor recognizes that electrical valves can fail either in the open or closed position, particularly if its components have been distorted by being frozen. Therefore, it is advantageous to provide a manual by-pass branch 12a (FIG. 4) including manual valve 12b, going around the electrical valve 12 and operable by the hand-operated valve 12b. The valve 12b can be opened if desired, to bypass the electrical valve 12, should it have failed in the closed position.

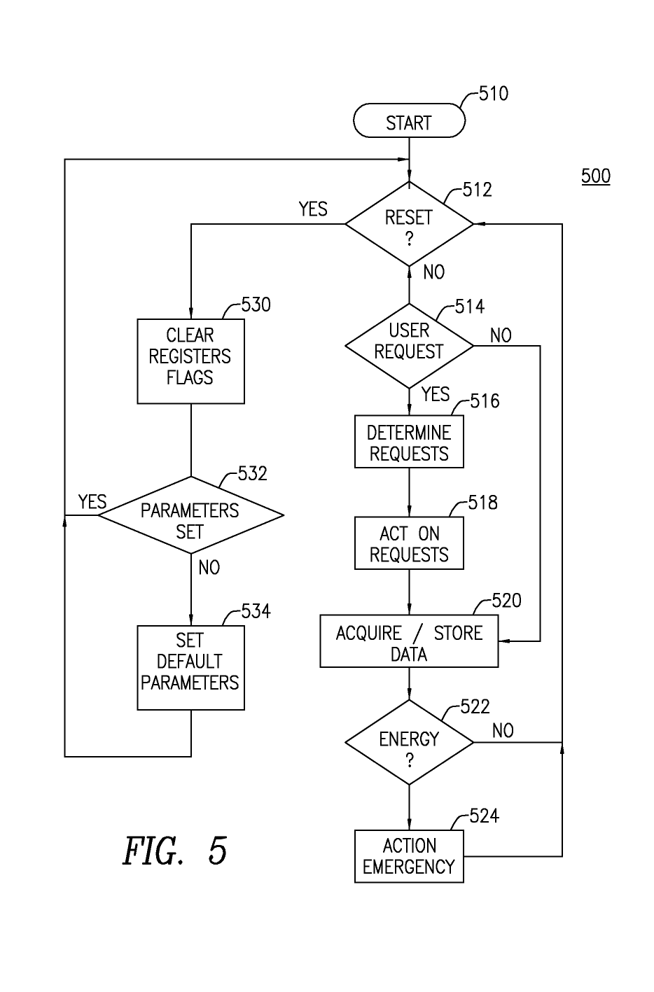

Reference is now made to FIG. 5, depicting a software/algorithm flowchart for the controller 50 of the present invention.

Upon commencement of execution of the software, the algorithm begins at start position 510. The internal software/algorithms executed by the controller 50 determine at decisional box 512 whether the system is operational or whether it requires going through an initialization. If it is operational, the algorithm proceeds to decisional box 514 to determine whether there has been any user request via the user interface 52 (FIG. 2). If yes, the nature of the request is determined at step 516 and thereafter, the processor 50 acts on the request at step 518.

The nature of the request can be to change the parameters of operation for the overall system, requesting, for example, that the process enter a “vacation mode” for certain durations indicative that a house would be vacant during that period. Or the operator may change the internal parameters. Or the operator may change the internal parameters to trigger an alarm when the deviation from the norm is greater or less than previously set. The processor 50 may react to an operator request to display or print or email a report of the internal information accumulated about water usage in the different water branches of the particular home. The software may include a facility that enables entering into computer the number of people occupying the home over certain periods of time. For example, if additional family members have come home from school or have arrived with their own families, the parameters for the system may be alerted based on the number of people in the particular home. A smart phone app can be used to notify the homeowner, and enable him/her to shut off the water from the smart phone or tablet.

In the event that there has not been a user request at step 514, the software proceeds to step 520 to execute its normal routine of acquiring and storing data from the various water flow meters previously described. The system can be set to acquire this information every few seconds or to acquire readings every few minutes, and so on, and also to store relevant information about water use to thereby develop a history or profile of water usage in the main branch, as well as, optionally, in the individual water branches over various time periods.

Upon noting that the water usage has entered out of the normal permitted, or expected, then a determination is made whether an emergency situation exists at the software module 522. If no emergency, the program returns to decisional box 512. However, if an emergency has been declared in the software, the processor 50 proceeds to module 524 to act on the emergency. The action on an emergency may be to shut off of the main water valve to the house or only the branch where a leak or an anomaly has been detected. Another action may be to place a telephone call with pre-stored voice messages to particular telephone numbers, or email addresses or the like. In addition, or alternatively, a voice message may be generated with the proper information, alerting the owner of the existence of the emergency situation. Once the emergency situation has been handled, the program returns to decisional box 512.

Assuming the decisional box 112 has determined the system requires reinitialization, the program then proceeds to software module 530, at which point it clears its various internal flags and registers and proceeds to the decisional box to find whether certain parameters for the system have been preset in memory and, if so, those parameters are loaded into the running program. If no particular parameters have been set, the program proceeds to box 534 to set default parameters for the system and thereafter, returns to the beginning. In this manner, this software runs continuously, even when power outages are experienced, given that the uninterrupted power supply 58 is always available to continue powering the processor controller 50, as already noted.

The alarm condition can be determined based on water flowing in the main branch or in a subsidiary branch exceeding a maximum time, or based on too great a water flow at a given instant, and similar conditions of alarm that would be apparent to one of ordinary skill in the art. The intelligent water emergency system may also drill down to the level where the system knows which branches are connected, for example, to a bathtub faucet, which uses greater quantities of water for short time durations and take this into account.

The invention includes the feature that emergency communications can be sent via, for example, an iPhone® or the like. A hardwired button may be pressed at any time for the processor, instructing it to override its own decision and to open all the valves when it is determined that a computer malfunction is causing unnecessary water shutoffs.

As described above, the present invention will be very helpful in today's world which is concerned with ECO feedback. The algorithms of the present invention enable a great deal to be learned about the residence's water consumption habits. It can identify and help stop unneeded water usage. The invention may also be configured to notify the Fire Department if a fire sprinkler draws too much water. As described above, the basic concept of the invention utilizes the tracking, “machine learning”, as well as “network technology”, to learn water usage habits and patterns and deploys electrical water valves to shut off leak sources. The invention learns the times and the amounts of water being used. Depending on the number of flow meters, it may be so that the system may not know where the water use is excessive. But it will know what time the water is being used, and how much water is being drawn. When the system detects changes at unexplainable times, or quantities, the invention can email or telephone the homeowner and signal the main water shut off valve to turn off using a motorized valve to stop any additional water flow, while opening a line to drain the house. There are hard-wired options for a hot water heater, and/or any other device. The notification can provide information about which device is drawing the water. The system of the invention is also implemented with a backup option so that if power is lost during the cold part of the winter, the valve is closed to save the house pipes from freezing. Other services can include setting vacation times, and when the draw should be very small or none at all. With remote access, one is able to communicate with the system, to override or change the settings if desired. As noted, the invention optionally includes various additional overflow meters so that it can track different risers or apartments within a building. The water flow can be shut off on a selective basis.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An intelligent water flow control system, comprising:
a main water flow source conduit for supplying water to a location having at least one water branch in liquid communication with the water source conduit;
at least one electrical valve located in line with the source conduit;
at least one water flow detector coupled to said at least one water branch;
a controller with internally stored software, said controller being electrically coupled to receive information from the at least one flow detector and coupled to output signals for controlling the at least one valve; and
wherein said controller is configured to executed software that is effective to gather information about water usage from information derived from said at least one flow detector and to develop information indicative of normal water usage at the location, and to make leakage determinations indicative of out-of-normal water usage at the location and to interact with said at least one valve to shut off water passage through said valve.

2. The system of claim 1, wherein said flow detector is a water flow meter.

3. The system of claim 1, wherein said location has plural water branches and each branch has its respective flow detector and its respective water control valve.

4. The system of claim 1, wherein said detector is a sound detector which develops a signal indicative of whether water is or is not flowing within said water branch.

5. The system of claim 1, further including a sump for sumping water that leaked at said location, said sump being in electrical communication with said controller.

6. The system of claim 5, wherein said sump is in fluid communication via a controllable electrical valve with at least of said water branches.

7. The system of claim 1, including a backup power supply for powering said controller.

8. The system of claim 1, including an operator interface enabling an operator to control and/or receive information from said controller.

9. The system of claim 8, wherein in said operator interface includes a facility for allowing a person to communicate with said controller wirelessly.

10. The system of claim 1, wherein said valve is in wireless communication with said controller.

11. The system of claim 1, wherein said detector is in wireless communication with said controller.

12. The system of claim 1, wherein said at least one valve has its own local source of electrical power.

13. The system of claim 1, wherein said software includes a module that is effective for developing a water usage profile.

14. The system of claim 13, wherein said water usage profile considers one or more of: water usage durations; times of day of water usage; operator entered parameters including one or more of a vacation mode; a number of people residing at the location and user contact information; instantaneous water quantities flowing from said water source; and water usage quantities flowing over a predetermined time period.

15. The system of claim, wherein said flowmeter comprises one of:
a mechanical flow meter, a pressure-based meter, an optical flow meter, an open-channel flow meter, a current meter, a mass flow meter, a vortex flow meter, an electromagnetic meter, an ultrasonic meter, a coriolis flow meter, and a Doppler flow meter.

16. The system of claim 1, further including a temperature sensor coupled to said controller.

17. The system of claim 3, wherein at least one of said water branches is associated with an openable door that provides access to said water branch to provide access for installing said at least one water flow detector thereat.
